(19) United States
(12) Patent Application Publication
(10) Pub. No.: US 2026/0066309 A1
(43) Pub. Date: Mar. 5, 2026

(54) THIN GAUGE ALUMINUM-BASED CATHODES FOR LITHIUM-ION BATTERIES

(71) Applicant: Novelis Inc., Atlanta, GA (US)

(72) Inventors: Martti Kaempgen, Hann Muenden (DE); DaeHoon Kang, Canton, GA (US); Timothy Francis Stanistreet, Acworth, GA (US)

(73) Assignee: Novelis Inc., Atlanta, GA (US)

(21) Appl. No.: 19/105,949

(22) PCT Filed: Aug. 31, 2023
(86) PCT No.: PCT/US2023/031629

§ 371 Date: Feb. 24, 2025

Related U.S. Application Data
(60) Provisional application No. 63/374,283, filed on Sep. 1, 2022.

(51) Int. Cl. H01M 4/66; H01M 4/02; H01M 4/04

(52) U.S. Cl. CPC H01M 4/662; H01M 4/0404; H01M 4/663; H01M 4/667; H01M 2004/021; H01M 2004/028

(57) ABSTRACT

Described are batteries and battery components including a cathode current collector comprising a 1xxx series aluminum alloy or an 8xxx series aluminum alloy. The cathode current collector can have a thickness of from 5 μm to 12 μm. In some examples, a cathode active material layer may be disposed over at least a portion of the cathode current collector. The cathode current collector may have both surfaces that are in contact with the active material layer being matte surfaces. Battery cells including the cathode current collector may retain a specific capacity above 90% of an initial specific capacity for up to 3000 cycles or more. Additionally, the battery cells including the cathode current collector may retain an energy density above 90% of an initial energy density for up to 3000 cycles or more.

### CROSS-REFERENCE TO RELATED APPLICATIONS

This application claims the benefit of and priority to U.S. Provisional Application No. 63/374,283, filed on Sep. 1, 2022, which is hereby incorporated by reference in its entirety.

### FIELD

The present disclosure relates to metallurgy generally and more specifically to improving battery current collectors and other components with thin gauge aluminum alloys, such as 1xxx series aluminum alloys or 8xxx series aluminum alloys.

### BACKGROUND

Conventional lithium-ion batteries generally include a cathode, an anode, and a separator soaked with an electrolyte between them. Current collectors on the cathode side and the anode side are used to conduct electrical current between the cathode and the anode, while the electrolyte allows lithium ions to transport between the cathode and the anode. Due to the potentials involved, copper is generally used as an anode current collector and aluminum is generally used as the cathode current collector. Lithium metal oxides, like lithium cobalt oxide, are commonly used as lithium-ion battery cathodes, and graphite is commonly used as lithium-ion battery anodes.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the detailed description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Described herein are battery components. An example battery component comprises a cathode current collector comprising a 1xxx series aluminum alloy or an 8xxx series aluminum alloy. The cathode current collector can have a thickness of from 5 μm to 12 μm. Optionally, the cathode current collector can have a thickness of from 7 μm to 10 μm. Example thicknesses can include from 5 μm to 5.1 μm, from 5.1 μm to 5.2 μm, from 5.2 μm to 5.3 μm, from 5.3 μm to 5.4 μm, from 5.4 μm to 5.5 μm, from 5.5 μm to 5.6 μm, from 5.6 μm to 5.7 μm, from 5.7 μm to 5.8 μm, from 5.8 μm to 5.9 μm, from 5.9 μm to 6.0 μm, from 6.0 μm to 6.1 μm, from 6.1 μm to 6.2 μm, from 6.2 μm to 6.3 μm, from 6.3 μm to 6.4 μm, from 6.4 μm to 6.5 μm, from 6.5 μm to 6.6 μm, from 6.6 μm to 6.7 μm, from 6.7 μm to 6.8 μm, from 6.8 μm to 6.9 μm, from 6.9 μm to 7.0 μm, from 7 μm to 7.1 μm, from 7.1 μm to 7.2 μm, from 7.2 μm to 7.3 μm, from 7.3 μm to 7.4 μm, from 7.4 μm to 7.5 μm, from 7.5 μm to 7.6 μm, from 7.6 μm to 7.7 μm, from 7.7 μm to 7.8 μm, from 7.8 μm to 7.9 μm, from 7.9 μm to 8 μm, from 8 μm to 8.1 μm, from 8.1 μm to 8.2 μm, from 8.2 μm to 8.3 μm, from 8.3 μm to 8.4 μm, from 8.4 μm to 8.5 μm, from 8.5 μm to 8.6 μm, from 8.6 μm to 8.7 μm, from 8.7 μm to 8.8 μm, from 8.8 μm to 8.9 μm, from 8.9 μm to 9 μm, from 9 μm to 9.1 μm, from 9.1 μm to 9.2 μm, from 9.2 μm to 9.3 μm, from 9.3 μm to 9.4 μm, from 9.4 μm to 9.5 μm, from 9.5 μm to 9.6 μm, from 9.6 μm to 9.7 μm, from 9.7 μm to 9.8 μm, from 9.8 μm to 9.9 μm, from 9.9 μm to 10 μm, from 10 μm to 10.1 μm, from 10.1 μm to 10.2 μm, from 10.2 μm to 10.3 μm, from 10.3 μm to 10.4 μm, from 10.4 μm to 10.5 μm, from 10.5 μm to 10.6 μm, from 10.6 μm to 10.7 μm, from 10.7 μm to 10.8 μm, from 10.8 μm to 10.9 μm, from 10.9 μm to 11 μm, from 11 μm to 11.1 μm, from 11.1 μm to 11.2 μm, from 11.2 μm to 11.3 μm, from 11.3 μm to 11.4 μm, from 11.4 μm to 11.5 μm, from 11.5 μm to 11.6 μm, from 11.6 μm to 11.7 μm, from 11.7 μm to 11.8 μm, from 11.8 μm to 11.9 μm, or from 11.9 μm to 12 μm.

In some examples, the battery component can further comprise an active material layer disposed over at least a portion of the cathode current collector. A side of the aluminum alloy facing the active material layer may be a shiny side. Alternatively, a side of the aluminum alloy facing the active material layer may be a matte side. A conductivity between the active material layer and the cathode current collector can range from 0.0275 S/m to 0.0675 S/m. Optionally, the conductivity between the active material layer and the cathode current collector can range from 0.04 S/m to 0.0675 S/m. Example conductivities between the first current collector and the first active material can be from about 0.0275 S/m to about 0.0675 S/m, such as from 0.0275 S/m to about 0.030 S/m, from 0.030 S/m to 0.035 S/m, from 0.035 S/m to 0.040 S/m, from 0.040 S/m to 0.045 S/m, from 0.045 S/m to 0.050 S/m, from 0.050 S/m to 0.055 S/m, from 0.055 S/m to 0.060 S/m, from 0.060 S/m to 0.065 S/m, or from 0.065 S/m to 0.0675 S/m.

In some examples, the cathode current collector can comprise a recycled content aluminum alloy. For example, the cathode current collector can comprise up to 50% recycled aluminum content. Example percentages of recycled aluminum content can include 0% recycled aluminum content, 1% recycled aluminum content, 2% recycled aluminum content, 3% recycled aluminum content, 4% recycled aluminum content, 5% recycled aluminum content, 6% recycled aluminum content, 7% recycled aluminum content, 8% recycled aluminum content, 9% recycled aluminum content, 10% recycled aluminum content, 11% recycled aluminum content, 12% recycled aluminum content, 13% recycled aluminum content, 14% recycled aluminum content, 15% recycled aluminum content, 16% recycled aluminum content, 17% recycled aluminum content, 18% recycled aluminum content, 19% recycled aluminum content, 20% recycled aluminum content, 21% recycled aluminum content, 22% recycled aluminum content, 23% recycled aluminum content, 24% recycled aluminum content, 25% recycled aluminum content, 26% recycled aluminum content, 27% recycled aluminum content, 28% recycled aluminum content, 29% recycled aluminum content, 30% recycled aluminum content, 31% recycled aluminum content, 32% recycled aluminum content, 33% recycled aluminum content, 34% recycled aluminum content, 35% recycled aluminum content, 36% recycled aluminum content, 37% recycled aluminum content, 38% recycled aluminum content, 39% recycled aluminum content, 40% recycled aluminum content, 41% recycled aluminum content, 42% recycled aluminum content, 43% recycled aluminum content, 44% recycled aluminum content, 45% recycled aluminum content, 46% recycled aluminum content, 47% recycled aluminum content, 48% recycled aluminum content, 49% recycled aluminum content, or 50% recycled aluminum content.

The battery component may retain a specific capacity above 90% of an initial specific capacity for up to 3000 cycles. For example, the cathode current collector may contribute to retention of a specific capacity above 90% of an initial specific capacity for up to 3000 cycles, up to 2500 cycles, up to 2000 cycles, up to 1500 cycles, up to 1000 cycles, up to 900 cycles, up to 800 cycles, up to 700 cycles, up to 600 cycles, up to 500 cycles, up to 400 cycles, up to 300 cycles, up to 200 cycles, up to 100 cycles, from 200 cycles to 3000 cycles, from 500 cycles to 1000 cycles, from 1000 cycles to 1500 cycles, from 1500 cycles to 2000 cycles, from 2000 cycles to 2500 cycles, or from 2500 cycles to 3000 cycles.

Optionally, the battery component may retain an energy density above 90% of an initial energy density for up to 3000 cycles. For example, the cathode current collector may contribute to retention of an energy density above 90% of an initial energy density for up to 3000 cycles, up to 2500 cycles, up to 2000 cycles, up to 1500 cycles, up to 1000 cycles, up to 900 cycles, up to 800 cycles, up to 700 cycles, up to 600 cycles, up to 500 cycles, up to 400 cycles, up to 300 cycles, up to 200 cycles, up to 100 cycles, from 200 cycles to 3000 cycles, from 500 cycles to 1000 cycles, from 1000 cycles to 1500 cycles, from 1500 cycles to 2000 cycles, from 2000 cycles to 2500 cycles, or from 2500 cycles to 3000 cycles.

In some examples, the battery component can further comprise a conductive layer disposed over at least a portion of a surface of the cathode current collector. The conductive layer may be a carbonaceous material. In some examples, the 8xxx series aluminum can be an 8079 series aluminum alloy, an 8090 series aluminum alloy, or an 8077 series aluminum alloy.

In some examples, the 8xxx series aluminum alloy can comprise Al and at least one of Si, Cu, Fe, or Zn. For example, the 8xxx series aluminum alloy can comprise up to 0.3 wt. % Si. Example percentages of Si in the thin gauge 8xxx series aluminum alloy can include up to 0.3 wt. %, up to 0.29 wt. %, up to 0.28 wt. %, up to 0.27 wt. %, up to 0.26 wt. %, up to 0.25 wt. %, up to 0.24 wt. %, up to 0.23 wt. %, up to 0.22 wt. %, up to 0.21 wt. %, up to 0.20 wt. %, up to 0.19 wt. %, up to 0.18 wt. %, up to 0.17 wt. %, up to 0.16 wt. %, up to 0.15 wt. %, up to 0.14 wt. %, up to 0.13 wt. %, up to 0.12 wt. %, up to 0.11 wt. %, up to 0.10 wt. %, up to 0.09 wt. %, up to 0.08 wt. %, up to 0.07 wt. %, up to 0.06 wt. %, up to 0.05 wt. %, up to 0.04 wt. %, up to 0.03 wt. %, up to 0.02 wt. %, up to 0.01 wt. %, from 0.05 wt. % to 0.10 wt. %, from 0.10 wt. % to 0.15 wt. %, from 0.15 wt. % to 0.20 wt. %, from 0.20 wt. % to 0.25 wt. %, or from 0.25 wt. % to 0.30 wt. %.

The 8xxx series aluminum alloy can comprise up to 0.05 wt. % Cu. Example percentages of Cu in the thin gauge 8xxx series aluminum alloy can include up to 0.05 wt. %, up to 0.04 wt. %, up to 0.03 wt. %, up to 0.02 wt. %, up to 0.01 wt. %, from 0.01 wt. % to 0.02 wt. %, from 0.02 wt. % to 0.03 wt. %, from 0.03 wt. % to 0.04 wt. %, or from 0.04 wt. % to 0.05 wt. %.

The 8xxx series aluminum alloy can comprise up to 1.3 wt. % Fe. Example percentages of Fe in the thin gauge 8xxx series aluminum alloy can include up to 1.3 wt. %, such as up to 1.2 wt. %, up to 1.1 wt. %, up to 1.0 wt. %, up to 0.9 wt. %, up to 0.8 wt. %, up to 0.7 wt. %, up to 0.6 wt. %, up to 0.5 wt. %, up to 0.4 wt. %, up to 0.3 wt. %, up to 0.2 wt. %, up to 0.1 wt. %, from 0.1 wt. % to 1.3 wt. %, from 0.2 wt. % to 0.3 wt. %, from 0.3 wt. % to 0.4 wt. %, from 0.4 wt. % to 0.5 wt. %, from 0.5 wt. % to 0.6 wt. %, from 0.6 wt. % to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, or from 1.2 wt. % to 1.3 wt. %.

The 8xxx series aluminum alloy can comprise up to 0.10 wt. % Zn. Example percentages of Zn can include up to 0.10 wt. %, up to 0.09 wt. %, up to 0.08 wt. %, up to 0.07 wt. %, up to 0.06 wt. %, up to 0.05 wt. %, up to 0.04 wt. %, up to 0.03 wt. %, up to 0.02 wt. %, up to 0.01 wt. %, from 0.01 wt. % to 0.02 wt. %, from 0.02 wt. % to 0.03 wt. %, from 0.03 wt. % to 0.04 wt. %, from 0.04 wt. % to 0.05 wt. %, from 0.05 wt. % to 0.06 wt. %, from 0.06 wt. % to 0.07 wt. %, from 0.07 wt. % to 0.08 wt. %, from 0.08 wt. % to 0.09 wt. %, or from 0.09 wt. % to 0.10 wt. %.

In some aspects, methods are described herein, such as methods for making battery components, such as from a 1xxx series aluminum alloy or an 8xxx series aluminum alloy. An example method of this aspect comprises providing a cathode current collector comprising a 1xxx series aluminum alloy or an 8xxx series aluminum alloy. The cathode current collector can have a thickness of from 5 μm to 12 μm. The method can further comprise applying a cathode active material over a surface of the cathode current collector. In some examples, the method can further comprise subjecting the cathode current collector to a coating process to form a conductive layer. The conductive layer may be carbonaceous material. Battery components made by the methods of this aspect may include any of those described herein.

In some aspects, a battery can comprise an anode and a cathode. The cathode can comprise any battery component described herein as a cathode current collector, and a cathode active material in contact with the cathode current collector. The battery can further comprise an electrolyte positioned between the cathode and the anode. The electrolyte can be a liquid electrolyte or a solid electrolyte.

In some examples, individual aluminum alloy current collectors (e.g., corresponding to aluminum foil layers) may have opposite surface configurations (e.g., one matte and one shiny) due to the rolling methods used to produce the aluminum alloy current collectors. In some examples, aluminum foils may be produced in pairs, such as where a first aluminum alloy substrate is positioned adjacent to a second aluminum alloy substrate during the rolling process in order to produce a pair of foils, sometimes referred to as a double rolled foil. In such a configuration, the surfaces of the foils that face one another will have dull or matte surfaces, while the surfaces of the foils that contact the rolling equipment will have bright or shiny surfaces. Dual rolling may be advantageously used for preparation of foils, for example, because such a rolling process may allow for increased production, since two foils can be produced during a single set of rolling operations. Further, by doubling the thickness when dual rolling two substrates, the roll gap may be about double the resultant thickness of the pair of foils (e.g., a 20 μm roll gap can be used when fabricating two 10 μm foils in contact with one another). The increased roll gap may be operationally more efficient, as larger roll gaps may be easier to maintain, but this configuration can still allow for achieving suitably thin foils.

For some aluminum alloy current collectors, it may be desirable for both surfaces to have shiny surface configurations. In some examples, this may be for aesthetic reasons, to improve operational consistency or for improved battery performance. In some cases, preparing aluminum foils, such as for use as aluminum alloy current collectors, where both top and bottom surfaces are shiny surfaces may be achieved by a single layer rolling with a small roll gap. In this way, both top and bottom surfaces of a single foil layer may be in contact with the rolling equipment and result in both surfaces having a shiny configuration or appearance.

For other aluminum alloy current collectors, it may be desirable for both surfaces to have matte surface configurations. In some examples, this may provide operational benefits or improved battery performance, such as where adhesion with active material is better as compared to adhesion with the shiny side. However, forming aluminum alloy foils where both surfaces have matte configurations cannot generally be achieved using the single rolling technique used for preparing foils where both surfaces are shiny or the double rolling technique used for preparing foils where the two surfaces of the foils have opposite configurations (e.g., one shiny and one matte). Aspects described herein overcome this issue and allow for preparation of aluminum foils where both surfaces have matte configurations.

Accordingly, in an aspect, methods are described herein for preparing aluminum foils where both surfaces of the foils have matte configurations. An example method of this aspect comprises feeding three or more aluminum alloy sheets to a roll stand to reduce a gauge of the three or more aluminum alloy sheets and produce three or more aluminum alloy foils. In such a rolling configuration, at least one of the aluminum alloy foils may have both surfaces exhibiting a matte surface configuration. For example, the aluminum foils having both surfaces exhibiting a matte surface configuration may only contact another aluminum layer and not the roll stand during rolling.

In some examples, the three or more aluminum alloy sheets may comprise three aluminum alloy sheets. Feeding three aluminum alloy sheets to a roll stand may be useful for achieving a productivity increase that is three times higher as compared to rolling a single aluminum alloy sheet (single rolling). Similarly, feeding three aluminum alloy sheets to a roll stand may be useful for achieving a productivity increase that is 1.5 times higher as compared to rolling a pair of aluminum alloy sheets (double rolling) using the same foil rolling practice. In such configuration a center sheet of the three sheets may have both surfaces with matte configurations after the rolling.

In some examples, the three or more aluminum alloy sheets may comprise four aluminum alloy sheets. Feeding four aluminum alloy sheets to a roll stand may be useful for achieving a productivity increase that is four times higher as compared to rolling a single aluminum alloy sheet (single rolling). Similarly, feeding four aluminum alloy sheets to a roll stand may be useful for achieving a productivity increase that is 2 times higher as compared to rolling a pair of aluminum alloy sheets (double rolling) using the same foil rolling practice. In such configuration a pair of center sheets of the four sheets may have both surfaces with matte configurations after the rolling.

In some examples, feeding the three or more aluminum alloy sheets to the roll stand may comprise feeding the three or more sheets each individually to the roll stand. In other examples, at least two of the three or more aluminum alloy sheets may be fed to the roll stand as a coupled pair of aluminum alloy sheets, such as having been subjected to a dual or co-rolling process (e.g., where the aluminum alloy sheets were rolled together as a pair and then optionally coiled together as a pair).

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 provides a schematic overview of an example method for making a thin gauge 1xxx series or 8xxx series aluminum alloy product.

FIG. 2 provides a schematic overview of an example method for making two thin gauge 1xxx series or 8xxx series aluminum alloy products where both products include one surface with a shiny finish and one surface with a matte finish.

FIG. 3 provides a schematic overview of an example method for making three thin gauge 1xxx series or 8xxx series aluminum alloy products where two products include one surface with a shiny finish and one surface with a matte finish and one product includes two surfaces with matte finishes.

FIG. 4 provides a schematic overview of an example method for making four thin gauge 1xxx series or 8xxx series aluminum alloy products where two products include one surface with a shiny finish and one surface with a matte finish and two products includes two surfaces with matte finishes.

FIG. 5 is a schematic illustration of an example lithium-ion battery cell including a thin gauge aluminum alloy cathode current collector.

FIG. 6 is a schematic illustration of an example pull-off test for a thin-gauge aluminum alloy cathode current collector.

FIG. 7 is a graph of an example testing process for battery cells comprising a thin-gauge aluminum alloy cathode current collector.

FIG. 8 is a graph depicting resulting adhesive strength from pull-off tests performed on example thin-gauge aluminum alloy cathode current collectors.

FIG. 9 is a graph depicting resulting specific conductivity for example thin-gauge aluminum alloy cathode current collectors.

FIG. 10 is a graph depicting resulting specific discharge capacities from cycling tests performed on example battery cells including thin-gauge aluminum alloy cathode current collectors.

FIG. 11 is a graph depicting resulting specific discharge capacities during a C rate test performed on example battery cells including thin-gauge aluminum alloy cathode current collectors.

FIG. 12 is a graph depicting resulting energy density levels at the cathode level during cycling tests performed on example battery cells including thin-gauge aluminum alloy cathode current collectors.

FIG. 13 is a graph depicting resulting energy density levels at the cathode level during C rate tests performed on example battery cells including thin-gauge aluminum alloy cathode current collectors.

### DETAILED DESCRIPTION

Described herein are battery components such as cathode current collectors that include thin gauge 1xxx series aluminum alloys or 8xxx series aluminum alloys. The cathode current collectors may have a thickness between 5 μm and 12 μm. A conventional cathode current collector is typically made from a 1xxx series aluminum alloy, such as a 1085 series aluminum alloy, that has a thickness between 12 μm and 50 μm. In some cases, battery cells including the conventional cathode current collector can have a cycle life of about 200 hours. In contrast, battery cells including a cathode current collector made from a thin gauge 1xxx series aluminum alloy or 8xxx series aluminum alloy, as described herein, may have a significantly larger cycle life than conventional cathode current collectors tested and fabricated under similar conditions. In some examples, battery cells including such a cathode current collector can have a cycle life that is between 600 and 800 hours, or more. In some examples, the specific capacity of the cathode incorporating such a current collector may stay above 90% of the original specific capacity during the cycle life, such as for up to 250 cycles, 300 cycles, 350 cycles, 400 cycles, 450 cycles, 500 cycles, 750 cycles, 1000 cycles, 1500 cycles, 2000 cycles, 3000 cycles, or more. Additionally, the energy density of the cathode incorporating such a current collector may stay above 90% of the original energy density during the cycle life, such as for up to 250 cycles, 300 cycles, 350 cycles, 400 cycles, 450 cycles, 500 cycles, 750 cycles, 1000 cycles, 1500 cycles, 2000 cycles, 3000 cycles, or more.

In some examples, the increased iron content of the 8xxx series aluminum alloy compared to the 1xxx series aluminum alloy can allow for a stronger and therefore thinner gauge. The decreased mass of the 8xxx series aluminum alloy in a thin gauge, as described herein, can provide increased energy density and specific capacity of the cathode incorporating a thin gauge 8xxx series aluminum alloy current collector. Other metals included in the 8xxx series aluminum alloy, such as Si, Cu, Fe, and Zn, may optionally contribute to the increased energy density and specific capacity of the cathode.

In some examples, manufacturing a thin gauge 1xxx series aluminum alloy or 8xxx series aluminum alloy may produce a shiny side and a matte side. The energy density, specific capacity, active material adhesion, or the like of a lithium-ion battery may be, impacted, controlled, or customized based on the side of the aluminum alloy current collector facing an active material layer within the lithium-ion battery. For example, orienting the matte side to face the active material layer may result in increased energy density, specific capacity, and active material adhesion of the lithium battery as compared to placing the shiny side to face the active material layer. The matte side may also have an improved conductivity or a lower interface resistance with the active material layer when the active material layer faces the matte side as compared to the shiny side.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm).

As used herein, a foil generally refers to an aluminum product having a thickness of less than about 0.20 mm. For example, a foil may have a thickness of less than about 0.20 mm, less than about 0.15 mm, less than about 0.10 mm, less than about 0.075 mm, less than about 0.05 mm, or less than about 0.025 mm. In some examples, a foil has a thickness of less than or about 0.010 mm, 0.009 mm, 0.008 mm, 0.007 mm, 0.006 mm, or 0.005 mm.

Reference may be made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked. A W condition or temper refers to an aluminum alloy after solution heat treatment.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

In the following examples, aluminum alloy products and their components may be described in terms of their elemental composition in weight percent (wt. %). In each alloy, the remainder is aluminum, with a maximum wt. % of 0.15% for the sum of all impurities.

Incidental elements, such as grain refiners and deoxidizers, or other additives may be present in the invention and may add other characteristics on their own without departing from or significantly altering the alloy described herein or the characteristics of the alloy described herein.

Unavoidable impurities, including materials or elements may be present in an alloy in minor amounts due to inherent properties of aluminum or leaching from contact with processing equipment. Some alloys, as described, may contain no more than about 0.25 wt. % of any element besides the alloying elements, incidental elements, and unavoidable impurities.

The terms “surface configuration” and “surface finish” are used herein to refer to a characteristic of a surface of a metal product, such as a rolled aluminum alloy product (e.g., an aluminum alloy sheet or aluminum alloy foil). Surface finishes can be characterized based on their appearance and can provide a qualitative or quantitative measure of how well a surface reflects light in a specular direction. Qualitative measures of surface finish may include matte finish or matte configuration on one end and glossy finish, glossy configuration, shiny finish, shiny configuration, bright configuration, or bright finish on the other end. For matte finish or matte configuration surface finishes, the specular gloss may be lower than for other surface finishes, such as glossy finish, glossy configuration, shiny finish, shiny configuration, bright configuration, or bright finish. Accordingly, finish configurations can be relative. Quantitative measures of surface finish may be determined using one or more standards, such as for measuring specular gloss. Example standards relevant to measurement of gloss include, but are not limited to ISO 2813, ISO 7668, ISO 7759, ASTM D523, ASTM D4039, ASTM C346, ASTM D457, ASTM D7163, JIS Z 8741, DIN 67530. In some examples, matte finish surfaces exhibit a low gloss level, such as a gloss level of about 30% or lower. In some examples, shiny, glossy, or bright finish surfaces exhibit a moderate or high gloss level, such as a gloss level of about 30% or more. Example gloss levels for matte finish surfaces may be less than or about 30%, less than or about 25%, than or about 20%, less than or about 15%, than or about 10%, or less than or about 5%. Example gloss levels for shiny, glossy, or bright surface finishes may be greater than or about 40%, greater than or about 45%, greater than or about 50%, greater than or about 55%, greater than or about 60%, greater than or about 65%, greater than or about 70%, greater than or about 75%, or greater than or about 80%. In some examples, surface roughness for shiny, glossy, or bright finish surfaces may be from about 0.01 μm to about 0.15 μm. In some examples, surface roughness for matte finish surfaces may be from about 0.15 μm to about 0.5 μm. Example surface roughness for shiny, glossy, or bright finish surfaces may be from 0.01 μm to 0.02 μm, from 0.02 μm to 0.03 μm, from 0.03 μm to 0.04 μm, from 0.04 μm to 0.05 μm, from 0.05 μm to 0.06 μm, from 0.06 μm to 0.07 μm, from 0.07 μm to 0.08 μm, from 0.08 μm to 0.09 μm, from 0.09 μm to 0.10 μm, from 0.10 μm to 0.11 μm, from 0.11 μm to 0.12 μm, from 0.12 μm to 0.13 μm, from 0.13 μm to 0.14 μm, or from 0.14 μm to 0.15 μm. Example surface roughness for matte finish surfaces may be from 0.15 μm to 0.16 μm, from 0.16 μm to 0.17 μm, from 0.17 μm to 0.18 μm, from 0.18 μm to 0.19 μm, from 0.19 μm to 0.20 μm, from 0.20 μm to 0.21 μm, from 0.21 μm to 0.22 μm, from 0.22 μm to 0.23 μm, from 0.23 μm to 0.24 μm, or from 0.24 μm to 0.25 μm, from 0.25 μm to 0.26 μm, from 0.26 μm to 0.27 μm, from 0.27 μm to 0.28 μm, from 0.28 μm to 0.29 μm, from 0.29 μm to 0.30 μm, from 0.30 μm to 0.31 μm, from 0.31 μm to 0.32 μm, from 0.32 μm to 0.33 μm, from 0.33 μm to 0.34 μm, or from 0.34 μm to 0.35 μm, from 0.35 μm to 0.36 μm, from 0.36 μm to 0.37 μm, from 0.37 μm to 0.38 μm, from 0.38 μm to 0.39 μm, from 0.39 μm to 0.40 μm, from 0.40 μm to 0.41 μm, from 0.41 μm to 0.42 μm, from 0.42 μm to 0.43 μm, from 0.43 μm to 0.44 μm, or from 0.44 μm to 0.45 μm, from 0.45 μm to 0.46 μm, from 0.46 μm to 0.47 μm, from 0.47 μm to 0.48 μm, from 0.48 μm to 0.49 μm, or from 0.19 μm to 0.20 μm.

### Methods of Producing the Alloys and Aluminum Alloy Products

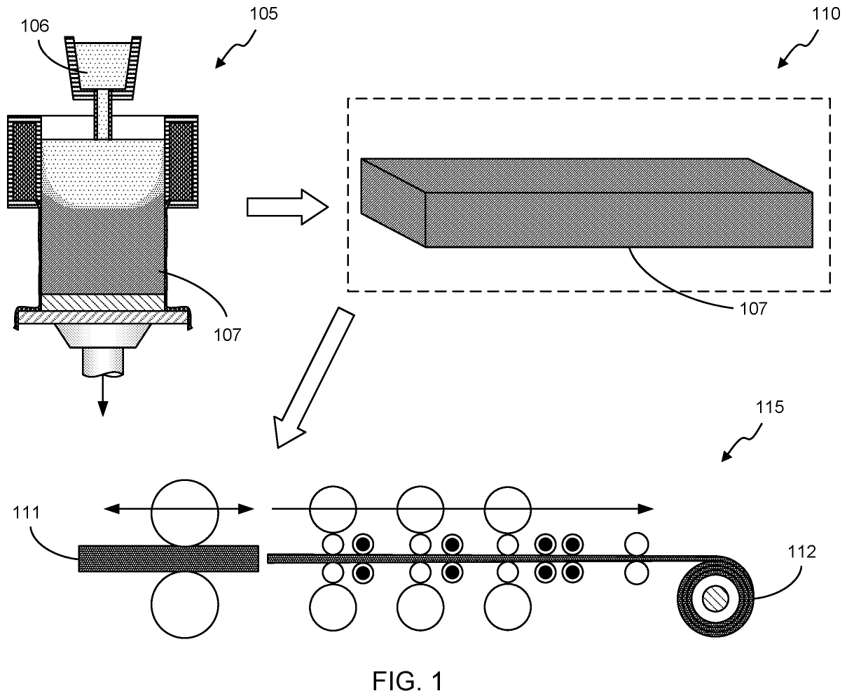

FIG. 1 provides a schematic overview of an example method for making a thin gauge 1xxx series aluminum alloy product or 8xxx series aluminum alloy product. The method of FIG. 1 may begin at step 105 where an aluminum alloy 106 may be cast to create a cast aluminum alloy product 107, such as an ingot or other cast product. At step 110, the cast aluminum alloy product 107 may be homogenized to form a homogenized aluminum alloy product 111. At step 115, the homogenized aluminum alloy product 111 may be subjected to one or more hot rolling passes and/or one or more cold rolling passes to form a rolled aluminum alloy product 112, which may correspond to an aluminum alloy article, such as an aluminum alloy plate, an aluminum alloy shate, or an aluminum alloy sheet. Optionally, the rolled aluminum alloy product 112 may be subjected to one or more forming or stamping processes to form an aluminum alloy article.

The thin gauge 1xxx series aluminum alloys and 8xxx series aluminum alloys described herein can be cast using any suitable casting method known to those of ordinary skill in the art. As a few non-limiting examples, the casting process can include a direct chill (DC) casting process or a continuous casting (CC) process. The continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A cast ingot, cast slab, or other cast product can be processed by any suitable means. Such processing steps include, but are not limited to, homogenization, hot rolling, cold rolling, solution heat treatment, and an optional pre-aging step.

In a homogenization step, a cast product is heated to a temperature ranging from about 400° C. to about 560° C. For example, the cast product can be heated to a temperature of about 400° C., about 410° C., about 420° C., about 430° C., about 440° C., about 450° C., about 460° C., about 470° C., about 480° C., about 490° C., about 490° C., about 500° C., about 510° C., about 520° C., about 520° C., about 540° C., about 550° C., or about 560° C. In some examples, homogenization is performed at a temperature within 50° C. of a solidus temperature of the cast product or alloy thereof. The product is then allowed to soak (i.e., held at the indicated temperature) for a period of time to form a homogenized product. In some examples, the total time for the homogenization step, including the heating and soaking phases, can be up to 24 hours. For example, the product can be heated up to 500° C. and soaked, for a total time of up to 18 hours for the homogenization step. Optionally, the product can be heated to below 490° C. and soaked, for a total time of greater than 18 hours for the homogenization step. In some cases, the homogenization step comprises multiple processes. In some non-limiting examples, the homogenization step includes heating a cast product to a first temperature for a first period of time followed by heating to a second temperature for a second period of time. For example, a cast product can be heated to about 465° C. for about 3.5 hours and then heated to about 480° C. for about 6 hours.

Following a homogenization step, a hot rolling step can be performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The homogenized product can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature between 300° C. to 450° C. For example, the continuously cast product can be allowed to cool to a temperature of between 325° C. to 425° C. or from 350° C. to 400° C. The continuously cast products can then be hot rolled at a temperature between 300° C. to 450° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled intermediate product upon exit from the hot rolling mill is no more than 470° C., no more than 450° C., no more than 440° C., or no more than 430° C.

Cast, homogenized, or hot-rolled products can be cold rolled using cold rolling mills into thinner products, such as a cold rolled sheet. The cold rolled product can have a gauge between about 0.5 to 10 mm, e.g., between about 0.7 to 6.5 mm. Optionally, the cold rolled product can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction) as compared to a gauge prior to the start of cold rolling. Optionally, an interannealing step can be performed during the cold rolling step, such as where a first cold rolling process is applied, followed by an annealing process (interannealing), followed by a second cold rolling process. The interannealing step can be performed at a temperature of from about 300° C. to about 450° C. (e.g., about 310° C., about 320° C., about 330° C., about 340° C., about 350° C., about 360° C., about 370° C., about 380° C., about 390° C., about 400° C., about 410° C., about 420° C., about 430° C., about 440° C., or about 450° C.). In some cases, the interannealing step comprises multiple processes. In some non-limiting examples, the interannealing step includes heating the partially cold rolled product to a first temperature for a first period of time followed by heating to a second temperature for a second period of time. For example, the partially cold rolled product can be heated to about 410° C. for about 1 hour and then heated to about 330° C. for about 2 hours.

Subsequently, a cast, homogenized, or rolled product can undergo a solution heat treatment step. The solution heat treatment step can be any suitable treatment for the sheet which results in solutionizing of the soluble particles. The cast, homogenized, or rolled product can be heated to a peak metal temperature (PMT) of up to 590° C. (e.g., from 400° C. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is rapidly cooled at rates greater than 200° C./s to a temperature between 500 and 200° C. to form a heat-treated product. In one example, the hot product is cooled at a quench rate of above 200° C./second at temperatures between 450° C. and 200° C. Optionally, the cooling rates can be faster in other cases.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

The cast products described herein can be used to make products in the form of sheets, plates, or other suitable products. For example, plates including the products as described herein can be prepared by processing an ingot in a homogenization step or casting a product in a continuous caster followed by a hot rolling step. In the hot rolling step, the cast product can be hot rolled to a 200 mm thick gauge or less (e.g., from about 10 mm to about 200 mm). For example, the cast product can be hot rolled to a plate having a final gauge thickness of about 10 mm to about 175 mm, about 15 mm to about 150 mm, about 20 mm to about 125 mm, about 25 mm to about 100 mm, about 30 mm to about 75 mm, or about 35 mm to about 50 mm. In some cases, plates may be rolled into thinner metal products, such as sheets.

Multiple rolling processes can be used to prepare rolled products from cast products. As indicated in FIG. 1, hot rolling and cold rolling can be used. In some examples, rolled products can be subjected to multiple cold rolling processes, such as to further reduce a thickness or gauge of the rolled product to a desired value. Optionally, multiple rolled products can be simultaneously rolled together at the same time, such as in a co-rolling process, where multiple rolled products are fed to a roll stand and subjected to a rolling process to reduce a gauge or thickness of each of the multiple rolled products.

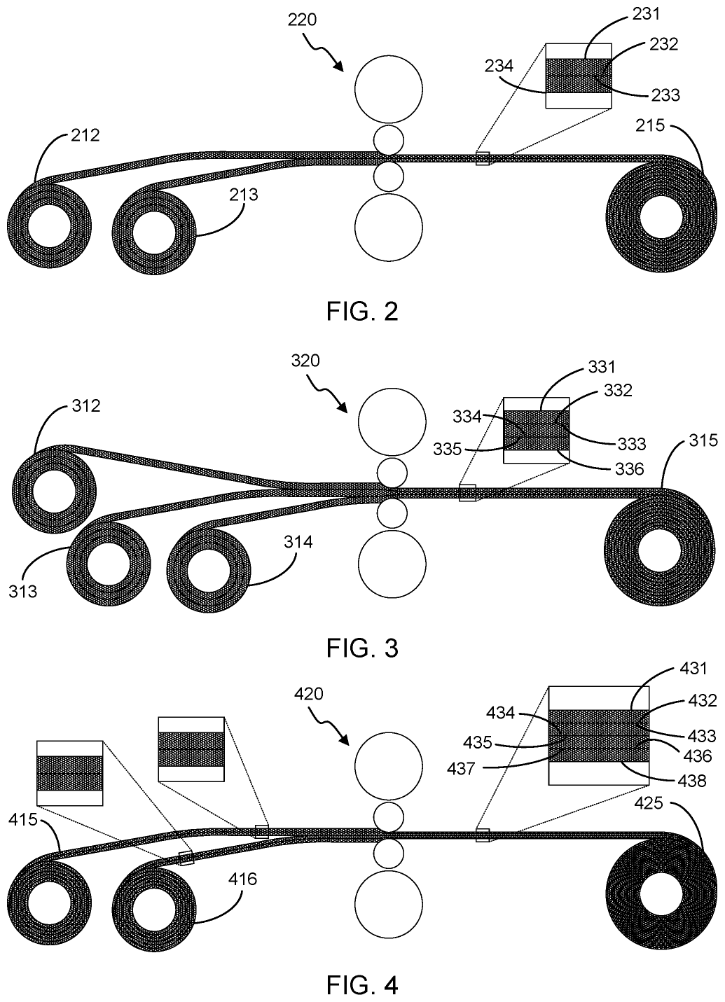

FIG. 2 provides an example where two rolled products 212 and 213 are subjected to a co-rolling process. As depicted in FIG. 2, rolled products 212 and 213 are fed to roll stand 220 to generate co-rolled product 215. Here, co-rolled rolled product 215 includes two rolled products as shown in the expanded inset of FIG. 2. The two rolled products of co-rolled product 215 can have the same or different thicknesses and may comprise the same or different aluminum alloys, depending on the thicknesses and alloys of rolled products 212 and 213. Co-rolling according to the process depicted in FIG. 2 may be useful for preparing aluminum alloy foils, and the co-rolling process can provide for double rolling throughput while using a larger gap between rollers of roll stand 220, as compared to rolling a single rolled product.

In the expanded inset, surfaces of the individual rolled products of co-rolled product 215 are identified. For the top rolled product, surfaces 231 and 232 are indicated. For the bottom rolled product, surfaces 233 and 234 are indicated. By co-rolling according to the scheme depicted in FIG. 2, surfaces 231 and 234 correspond to surfaces of the individual rolled products of co-rolled product 215 that come into contact with the rollers of roll stand 220 and these surfaces may exhibit a relatively bright or shiny surface. In contrast, surfaces 232 and 233 correspond to surfaces of the individual rolled products of co-rolled product 215 that only come into contact with one another, and these surfaces may exhibit a matte surface finish. Thus, each of the individual rolled products of co-rolled product 215 may include one surface with a shiny finish and one surface with a matte finish.

FIG. 3 provides an example where three rolled products 312, 313, and 313 are subjected to a co-rolling process. As depicted in FIG. 3, rolled products 312, 313, and 314 are fed to roll stand 320 to generate co-rolled product 315. Here, co-rolled rolled product 315 includes three rolled products as shown in the expanded inset of FIG. 3. The three rolled products of co-rolled product 315 can have the same or different thicknesses and may comprise the same or different aluminum alloys, depending on the thicknesses and alloys of rolled products 312, 313, and 314. Co-rolling according to the process depicted in FIG. 3 may be useful for preparing aluminum alloy foils, and the co-rolling process can provide for triple rolling throughput while using a larger gap between rollers of roll stand 320, as compared to rolling a single rolled product.

In the expanded inset, surfaces of the individual rolled products of co-rolled product 315 are identified. For the top rolled product, surfaces 331 and 332 are indicated. For the middle rolled product, surfaces 333 and 334 are indicated. For the bottom rolled product, surfaces 335 and 336 are indicated. By co-rolling according to the scheme depicted in FIG. 3, surfaces 331 and 336 correspond to surfaces of the individual rolled products of co-rolled product 315 that come into contact with the rollers of roll stand 320 and these surfaces may exhibit a relatively bright or shiny surface. In contrast, surfaces 332, 333, 334, and 335 correspond to surfaces of the individual rolled products of co-rolled product 315 that only come into contact with another aluminum alloy product surface and not a roller surface, and these surfaces may exhibit a matte surface finish. Thus, the top and bottom rolled products of co-rolled product 315 may each include one surface (331 and 336) with a shiny finish and one surface (332 and 335) with a matte finish, while the middle rolled product of co-rolled product 315 may include both surfaces (333 and 334) with matte finishes.

FIG. 4 provides an example where two co-rolled products 415 and 416 are subjected to a co-rolling process, which may be a second co-rolling process. As depicted in FIG. 4, co-rolled products 415 and 416 each include two individual rolled products as shown in the expanded insets on the left side of FIG. 4. The co-rolled products 415 and 416 are fed to roll stand 420 to generate co-rolled product 425. Here, co-rolled rolled product 425 includes four rolled products as shown in the expanded inset on the right side of FIG. 4. The four rolled products of co-rolled product 415 can have the same or different thicknesses and may comprise the same or different aluminum alloys, depending on the thicknesses and alloys of co-rolled products 415 and 416.

Co-rolling according to the process depicted in FIG. 4 may be useful for preparing aluminum alloy foils, and the co-rolling process can provide for quadruple rolling throughput while using a larger gap between rollers of roll stand 420, as compared to rolling a single rolled product. Moreover, the rolling configuration shown in FIG. 4 may be identical or substantially identical to that depicted in FIG. 2, except for the substitution of co-rolled products 415 and 416 in place of rolled products 212 and 213. Such a configuration may be advantageous in that no change to the rolling configuration may be needed, such as when compared to the rolling configuration of FIG. 3, which is adapted to include a third rolled product on the left side.

In the expanded inset on the right side of FIG. 4, surfaces of the individual rolled products of co-rolled product 415 are identified. For the top rolled product, surfaces 431 and 432 are indicated. For the upper middle rolled product, surfaces 433 and 434 are indicated. For the lower middle rolled product, surfaces 435 and 436 are indicated. For the bottom rolled product, surfaces 437 and 438 are indicated. By co-rolling according to the scheme depicted in FIG. 4, surfaces 431 and 338 correspond to surfaces of the individual rolled products of co-rolled product 415 that come into contact with the rollers of roll stand 420 and these surfaces may exhibit a relatively bright or shiny surface. In contrast, surfaces 432, 433, 434, 435, 436, and 437 correspond to surfaces of the individual rolled products of co-rolled product 415 that only come into contact with another aluminum alloy product surface and not a roller surface, and these surfaces may exhibit a matte surface finish. Thus, the top and bottom rolled products of co-rolled product 415 may each include one surface (431 and 438) with a shiny finish and one surface (432 and 437) with a matte finish, while the upper and lower middle rolled products of co-rolled product 415 may include both surfaces (433, 434, 435, and 436) with matte finishes.

### Methods of Using Metals and Metal Alloys

Described herein are methods of using metals and metal alloys, including aluminum, aluminum alloys, magnesium, magnesium alloys, magnesium composites, and steel, among others, and the resultant treated metals and metal alloys. In some examples, the metals for use in the methods described herein include aluminum alloys, for example, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. Optionally, 8xxx series alloys, useful in the thin gauge aluminum alloy products described herein can include recycle content, which may contain one or more of a 1xxx series aluminum alloy, a 2xxx series aluminum alloy, a 3xxx series aluminum alloy, a 4xxx series aluminum alloy, a 5xxx series aluminum alloy, a 6xxx series aluminum alloy, a 7xxx series aluminum alloy, or an 8xxx series aluminum alloy. In some examples, the materials for use in the methods described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets used in composites, or any other suitable metal, non-metal or combination of materials. Monolithic as well as non-monolithic, such as roll-bonded materials, cladded alloys, clad layers, composite materials, such as but not limited to carbon fiber-containing materials, or various other materials are also useful with the methods described herein. In some examples, aluminum alloys containing iron are useful with the methods described herein.

By way of non-limiting example, exemplary 1xxx series aluminum alloys for use in the methods described herein can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series aluminum alloys for use in the methods described herein can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys for use in the methods described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series aluminum alloys for use in the methods described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series aluminum alloys for use in the methods described herein product can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series aluminum alloys for use in the methods described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series aluminum alloys for use in the methods described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys for use in the methods described herein can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

### Battery Components

The aluminum alloy products described herein can be used in electronics applications. For example, the aluminum alloy products and methods described herein can be used to prepare current collectors and/or battery electrodes (e.g., aluminum-containing electrodes), such as for use in Li-ion batteries.

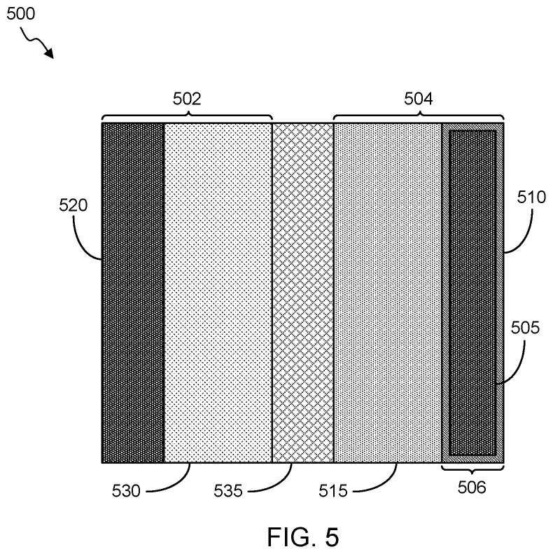

FIG. 5 is a schematic illustration of an example lithium-ion battery cell 500 including a thin gauge aluminum cathode current collector. The lithium-ion battery 500 includes a first electrode 502, which may correspond to a cathode in some examples, and a second electrode 504, which may correspond to an anode in some examples. The first electrode 502 of the lithium-ion battery 500 includes a first current collector 520. In some examples, the first current collector 520 may comprise a thin gauge 1xxx series aluminum alloy or a thin gauge 8xxx series aluminum alloy. The first electrode 502 also includes a first active material 530, such as a cathode active material. The second electrode 504 of the lithium-ion battery 500 includes a second current collector 506 and a second active material 515, such as an anode active material. As illustrated, second current collector 506 includes an alloy layer 505 (as a second current collector), such as an aluminum alloy layer or a copper alloy layer, and a coating layer 510. In some examples, the alloy layer 505 may comprise a thin gauge 1xxx series aluminum alloy or a thin gauge 8xxx series aluminum alloy. Although lithium-ion battery 500 depicted in FIG. 5 is described above with reference to current collector 520 being uncoated and current collector 506 including coating 510, such configuration is not intended to be limiting and one or both current first collector 520 and second current collector 506 can include a coating layer or can exclude a coating layer. In the case where second current collector 506 does not include a coating layer, the second current collector may comprise, consist of, or consist essentially of the alloy layer 505.

The coating 510 may be useful for preventing materials from directly contacting the alloy layer 505 of the second current collector 506 or the material of the first current collector 520. In some examples, the coating 510 may serve to block or otherwise prevent transmission of certain materials, such as to limit contact of those materials with a thin gauge 1xxx series aluminum alloy or a thin gauge 8xxx series aluminum alloy. In some examples, the coating 510 can serve to prevent lithium or lithium ions from contacting the alloy layer 505. Optionally, the coating 510 may be conductive and allow electrons to pass to the thin gauge 1xxx series aluminum alloy or the thin gauge 8xxx series aluminum alloy. In some examples, the coating 510 can be a carbonaceous material. Examples of the carbonaceous material can include a carbon black material or a Ketjenblack material.

Lithium-ion battery 500 also includes a separator and/or an electrolyte, illustrated as component 535. A separator and/or electrolyte are useful for preventing the first electrode active material and the second electrode active material from contacting one another while still allowing ions to be transported across during charging or discharging. Example separators may be or include non-reactive porous materials, such as polymeric membranes like polypropylene, poly(methyl methacrylate), or polyacrylonitrile. Example electrolytes may be or include an organic solvent, such as ethylene carbonate, dimethyl carbonate, or diethyl carbonate, or solid or ceramic electrolytes. Electrolytes may include dissolved lithium salts, such as LiPF₆, LiBF₄, or LiClO₄, and other additives.

The lithium-ion battery 500 may be used in or as components of other devices, such as portable electronic devices, mobile phones, tablet computers, or the like. For example, the first current collector 520 and second current collector 506 of the lithium-ion battery 500 may be positioned in direct or indirect communication with and receiving or providing current to an electronic device or circuitry of an electronic device.

In some examples, the first current collector 520 may comprise a 1xxx series aluminum alloy or an 8xxx series aluminum alloy having a thickness from about 5 μm to about 12 μm. Optionally, the first current collector 520 can have a thickness of from about 7 μm to about 12 μm. Example thicknesses can include from 5 μm to 5.1 μm, from 5.1 μm to 5.2 μm, from 5.2 μm to 5.3 μm, from 5.3 μm to 5.4 μm, from 5.4 μm to 5.5 μm, from 5.5 μm to 5.6 μm, from 5.6 μm to 5.7 μm, from 5.7 μm to 5.8 μm, from 5.8 μm to 5.9 μm, from 5.9 μm to 6.0 μm, from 6.0 μm to 6.1 μm, from 6.1 μm to 6.2 μm, from 6.2 μm to 6.3 μm, from 6.3 μm to 6.4 μm, from 6.4 μm to 6.5 μm, from 6.5 μm to 6.6 μm, from 6.6 μm to 6.7 μm, from 6.7 μm to 6.8 μm, from 6.8 μm to 6.9 μm, from 6.9 μm to 7.0 μm, from 7 μm to 7.1 μm, from 7.1 μm to 7.2 μm, from 7.2 μm to 7.3 μm, from 7.3 μm to 7.4 μm, from 7.4 μm to 7.5 μm, from 7.5 μm to 7.6 μm, from 7.6 μm to 7.7 μm, from 7.7 μm to 7.8 μm, from 7.8 μm to 7.9 μm, from 7.9 μm to 8 μm, from 8 μm to 8.1 μm, from 8.1 μm to 8.2 μm, from 8.2 μm to 8.3 μm, from 8.3 μm to 8.4 μm, from 8.4 μm to 8.5 μm, from 8.5 μm to 8.6 μm, from 8.6 μm to 8.7 μm, from 8.7 μm to 8.8 μm, from 8.8 μm to 8.9 μm, from 8.9 μm to 9 μm, from 9 μm to 9.1 μm, from 9.1 μm to 9.2 μm, from 9.2 μm to 9.3 μm, from 9.3 μm to 9.4 μm, from 9.4 μm to 9.5 μm, from 9.5 μm to 9.6 μm, from 9.6 μm to 9.7 μm, from 9.7 μm to 9.8 μm, from 9.8 μm to 9.9 μm, from 9.9 μm to 10 μm, from 10 μm to 10.1 μm, from 10.1 μm to 10.2 μm, from 10.2 μm to 10.3 μm, from 10.3 μm to 10.4 μm, from 10.4 μm to 10.5 μm, from 10.5 μm to 10.6 μm, from 10.6 μm to 10.7 μm, from 10.7 μm to 10.8 μm, from 10.8 μm to 10.9 μm, from 10.9 μm to 11 μm, from 11 μm to 11.1 μm, from 11.1 μm to 11.2 μm, from 11.2 μm to 11.3 μm, from 11.3 μm to 11.4 μm, from 11.4 μm to 11.5 μm, from 11.5 μm to 11.6 μm, from 11.6 μm to 11.7 μm, from 11.7 μm to 11.8 μm, from 11.8 μm to 11.9 μm, or from 11.9 μm to 12 μm.

Example 8xxx series aluminum alloys can include AA8079, AA8090, or AA8077. In some examples, the first current collector 520 may contribute an improvement in specific capacity and/or energy density due to high iron content in the thin gauge 8xxx series aluminum alloy providing for increased strength and/or a reduction in thickness of the current collector as compared to other aluminum alloys, such as 1xxx series aluminum alloys. Additional elements in the thin gauge 8xxx series aluminum may also similarly contribute to an increase in the specific capacity and energy density, such as Fe, Si, Cu, or Zn, due to improving strength characteristics allowing for a reduction in thickness of the current collector.

Example percentages of Fe in the thin gauge 8xxx series aluminum alloy can include up to 1.3 wt. %, such as up to 1.2 wt. %, up to 1.1 wt. %, up to 1.0 wt. %, up to 0.9 wt. %, up to 0.8 wt. %, up to 0.7 wt. %, up to 0.6 wt. %, up to 0.5 wt. %, up to 0.4 wt. %, up to 0.3 wt. %, up to 0.2 wt. %, up to 0.1 wt. %, from 0.1 wt. % to 1.3 wt. %, from 0.2 wt. % to 0.3 wt. %, from 0.3 wt. % to 0.4 wt. %, from 0.4 wt. % to 0.5 wt. %, from 0.5 wt. % to 0.6 wt. %, from 0.6 wt. % to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, or from 1.2 wt. % to 1.3 wt. %.

Example percentages of Si in the thin gauge 8xxx series aluminum alloy can include up to 0.3 wt. %, up to 0.29 wt. %, up to 0.28 wt. %, up to 0.27 wt. %, up to 0.26 wt. %, up to 0.25 wt. %, up to 0.24 wt. %, up to 0.23 wt. %, up to 0.22 wt. %, up to 0.21 wt. %, up to 0.20 wt. %, up to 0.19 wt. %, up to 0.18 wt. %, up to 0.17 wt. %, up to 0.16 wt. %, up to 0.15 wt. %, up to 0.14 wt. %, up to 0.13 wt. %, up to 0.12 wt. %, up to 0.11 wt. %, up to 0.10 wt. %, up to 0.09 wt. %, up to 0.08 wt. %, up to 0.07 wt. %, up to 0.06 wt. %, up to 0.05 wt. %, up to 0.04 wt. %, up to 0.03 wt. %, up to 0.02 wt. %, up to 0.01 wt. %, from 0.05 wt. % to 0.10 wt. %, from 0.10 wt. % to 0.15 wt. %, from 0.15 wt. % to 0.20 wt. %, from 0.20 wt. % to 0.25 wt. %, or from 0.25 wt. % to 0.30 wt. %.

Example percentages of Cu in the thin gauge 8xxx series aluminum alloy can include up to 0.05 wt. %, up to 0.04 wt. %, up to 0.03 wt. %, up to 0.02 wt. %, up to 0.01 wt. %, from 0.01 wt. % to 0.02 wt. %, from 0.02 wt. % to 0.03 wt. %, from 0.03 wt. % to 0.04 wt. %, or from 0.04 wt. % to 0.05 wt. %.

Example percentages of Zn in the thin gauge 8xxx series aluminum alloy can include up to 0.10 wt. %, up to 0.09 wt. %, up to 0.08 wt. %, up to 0.07 wt. %, up to 0.06 wt. %, up to 0.05 wt. %, up to 0.04 wt. %, up to 0.03 wt. %, up to 0.02 wt. %, up to 0.01 wt. %, from 0.01 wt. % to 0.02 wt. %, from 0.02 wt. % to 0.03 wt. %, from 0.03 wt. % to 0.04 wt. %, from 0.04 wt. % to 0.05 wt. %, from 0.05 wt. % to 0.06 wt. %, from 0.06 wt. % to 0.07 wt. %, from 0.07 wt. % to 0.08 wt. %, from 0.08 wt. % to 0.09 wt. %, or from 0.09 wt. % to 0.10 wt. %.

In some examples, producing the thin gauge 8xxx series aluminum alloy that comprises the first current collector 520 can result in a shiny side and a matte side. A conductivity between the first current collector 520 and the first active material 530 may be affected by the side of the thin gauge 8xxx series aluminum alloy that is facing the first active material 530. In some examples, arranging the first current collector 520 such that the matte side of the thin gauge 8xxx series aluminum alloy is facing the first active material 530 may result in higher conductivities between the first current collector 520 and the first active material 530 as compared to arranging the shiny side of the thin gauge 8xxx series aluminum alloy to face the first active material 530.

Example conductivities between the first current collector 520 and the first active material 530 can be from about 0.0275 S/m to about 0.0675 S/m, such as from 0.0275 S/m to about 0.030 S/m, from 0.030 S/m to 0.035 S/m, from 0.035 S/m to 0.040 S/m, from 0.040 S/m to 0.045 S/m, from 0.045 S/m to 0.050 S/m, from 0.050 S/m to 0.055 S/m, from 0.055 S/m to 0.060 S/m, from 0.060 S/m to 0.065 S/m, or from 0.065 S/m to 0.0675 S/m.

In some examples, the first current collector 520 may contribute to retention of specific capacity above 90% of an initial specific capacity for the battery 500 or electrode 502 for a certain number of cycles. For example, the first current collector 520 may contribute to retention of a specific capacity above 90% of an initial specific capacity for up to 3000 cycles, up to 2500 cycles, up to 2000 cycles, up to 1500 cycles, up to 1000 cycles, up to 900 cycles, up to 800 cycles, up to 700 cycles, up to 600 cycles, up to 500 cycles, up to 400 cycles, up to 300 cycles, up to 200 cycles, up to 100 cycles, from 200 cycles to 3000 cycles, from 500 cycles to 1000 cycles, from 1000 cycles to 1500 cycles, from 1500 cycles to 2000 cycles, from 2000 cycles to 2500 cycles, or from 2500 cycles to 3000 cycles.

Additionally, the first current collector 520 may contribute to retention of an energy density above 90% of an initial energy density for the battery 500 or electrode 502 for a certain number of cycles, such as up to 3000 cycles or more. For example, the first current collector 520 may contribute to retention of an energy density above 90% of an initial energy density for up to 3000 cycles, up to 2500 cycles, up to 2000 cycles, up to 1500 cycles, up to 1000 cycles, up to 900 cycles, up to 800 cycles, up to 700 cycles, up to 600 cycles, up to 500 cycles, up to 400 cycles, up to 300 cycles, up to 200 cycles, up to 100 cycles, from 200 cycles to 3000 cycles, from 500 cycles to 1000 cycles, from 1000 cycles to 1500 cycles, from 1500 cycles to 2000 cycles, from 2000 cycles to 2500 cycles, or from 2500 cycles to 3000 cycles.

In some examples, the first current collector 520 and/or the second current collector 506 or the alloy layer 505 may be or comprise a foil, such as a rolled aluminum foil. In some examples, the first current collector 520 may include or comprise a recycled content aluminum alloy, such as generated using one or more 1xxx series aluminum alloys, 2xxx series aluminum alloys, 3xxx series aluminum alloys, 3xxx series aluminum alloys, 4xxx series aluminum alloys, 5xxx series aluminum alloys, 6xxx series aluminum alloys, or 7xxx series aluminum alloys. In some examples, the first current collector 520 may comprise up to 50% recycled aluminum content. For example, the first current collector 520 can include 0% recycled aluminum content, 1% recycled aluminum content, 2% recycled aluminum content, 3% recycled aluminum content, 4% recycled aluminum content, 5% recycled aluminum content, 6% recycled aluminum content, 7% recycled aluminum content, 8% recycled aluminum content, 9% recycled aluminum content, 10% recycled aluminum content, 11% recycled aluminum content, 12% recycled aluminum content, 13% recycled aluminum content, 14% recycled aluminum content, 15% recycled aluminum content, 16% recycled aluminum content, 17% recycled aluminum content, 18% recycled aluminum content, 19% recycled aluminum content, 20% recycled aluminum content, 21% recycled aluminum content, 22% recycled aluminum content, 23% recycled aluminum content, 24% recycled aluminum content, 25% recycled aluminum content, 26% recycled aluminum content, 27% recycled aluminum content, 28% recycled aluminum content, 29% recycled aluminum content, 30% recycled aluminum content, 31% recycled aluminum content, 32% recycled aluminum content, 33% recycled aluminum content, 34% recycled aluminum content, 35% recycled aluminum content, 36% recycled aluminum content, 37% recycled aluminum content, 38% recycled aluminum content, 39% recycled aluminum content, 40% recycled aluminum content, 41% recycled aluminum content, 42% recycled aluminum content, 43% recycled aluminum content, 44% recycled aluminum content, 45% recycled aluminum content, 46% recycled aluminum content, 47% recycled aluminum content, 48% recycled aluminum content, 49% recycled aluminum content, or 50% recycled aluminum content.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### Example 1

In these series of tests, aluminum substrates, also referred to herein as cathode current collectors, were examined for their suitability for the production of cathodes for lithium-ion batteries. Three substrates were tested: a cathode made from a current collector comprising AA8079 with a thickness of 7 μm and coated on the matte side with a cathode active material, a cathode made from a current collector comprising AA8079 with a thickness of 7 μm and coated on the shiny side with a cathode active material, and a conventional cathode made from a current collector comprising AA1085 with a thickness of 16 μm and coated on the matte side with a cathode active material. For this purpose, the current collector substrates were coated with a suspension of active material (NMC-622), a conductive material, and a binder in a discontinuous process. The coating was done on one side of the current collector substrate. Because the current collector substrates can have a matte side (e.g., a “rough” side) and a shiny side (e.g., a “smooth” side) due to their production, the effect of the roughness of the aluminum current collector substrate on the cathode was investigated. Additionally, the conductivity, adhesion of the coating, and the discharging capacities achieved using the various current collector substrates were examined.

The composition of the coating on the substrate is depicted below in Table 1.

TABLE 1

| Component | Material | Mass Fraction [%] |
|---|---|---|
| Active Material | NCM-622 | 95.5 |
| Conductive Material | Super C65 | 1.5 |
| Conductive Material | SFG 6L | 0.75 |
| Binder | PVDF 5130 | 2.25 |

The suspension was produced using a dissolver (Dispermat CA, VMA-Getzmann). Table 2 depicts the dispersion parameters.

TABLE 2

| Dispersing Time | 60 | min |
|---|---|---|
| Temperature | 15° | C. |
| Diameter of Dissolver Wheel | 50 | mm |
| Circumferential Speed of the | 9 | m/s |
| Dissolver Wheel | | |
| Vessel Volume | 1000 | mL |

Following the dispersion, the suspension was degassed under reduced pressure for 15 minutes. The substrates were coated discontinuously under a film applicator (ZAA 2300, Zehntner Testing Instruments), aiming for a surface coating of 15.8 mg/cm². After the coating, the cathodes were compressed to a density of 3 g/cm³ using a calender (GKL 400, Saueressig GmbH & Co. KG).

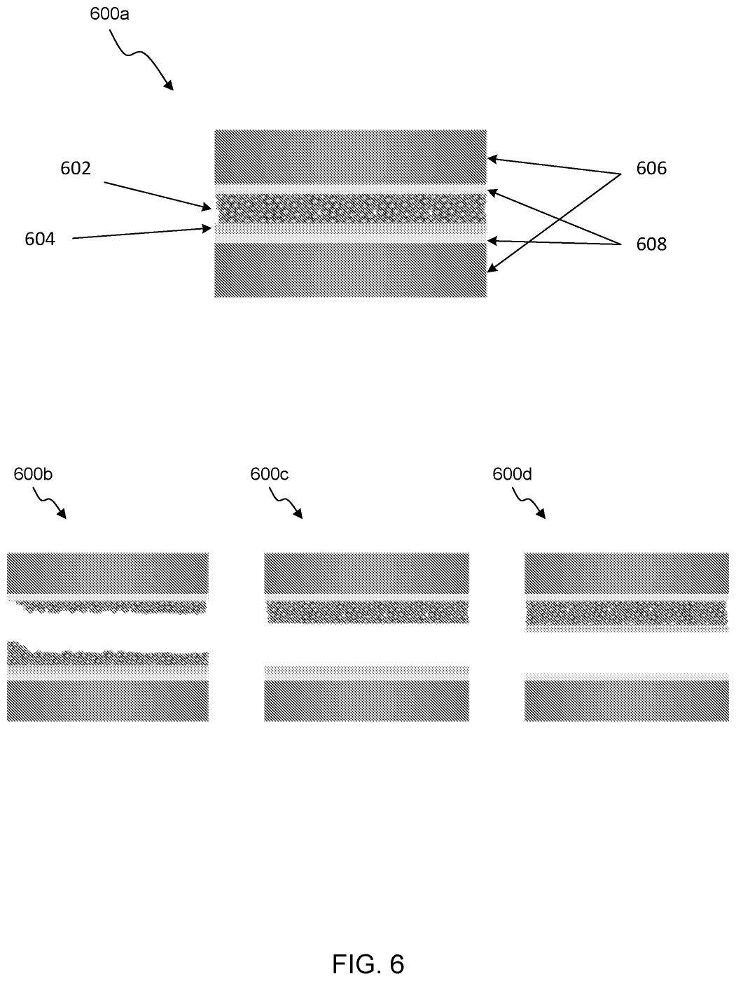

FIG. 6 is a schematic illustration of an example pull-off test for a thin-gauge aluminum alloy substrate 604. The adhesive strength of the aluminum alloy substrate 604 was determined by means of a pull-off test on a Z020 materials testing machine from Zwick GmbH. The aluminum alloy substrate 604 was first pressed together between two sample holders 606, which were covered in adhesive tape 608, with a defined force. The sample holders 606 were then pulled apart while measuring the force. The adhesive strength was determined from the maximum tensile force and the stressed area. Different failure mechanisms can occur with coatings 602 on the aluminum alloy substrate 604 using the pull-off test. Element 600a depicts the aluminum alloy substrate 604 prior to the pull-off test. Elements 600b, 600c, and 600d depict failure mechanisms after the pull-off test. Element 600b depicts cohesive failure within the coating 602, as the coating 602 can be detected on both the adhesive tape 608 and the aluminum alloy substrate 604. Element 600c depicts adhesive failure if blank film can be detected after the pull-off test. Element 600d depicts adhesive tape failure if the adhesive tape 608 failed during the test.

To investigate the conductivity of the cathodes, the cathodes were pressed together in a sample holder 606 on a Z020 testing machine from Zwick GmbH with a force of 40 N. The voltage drop within the sample was determined using a RESISTOMAT 2329 resistance measuring device from Burster Präzisionsmesstechnik Gmbh & Co KG at a constant current. The results of the conductivity tests are described below in relation to FIG. 9.

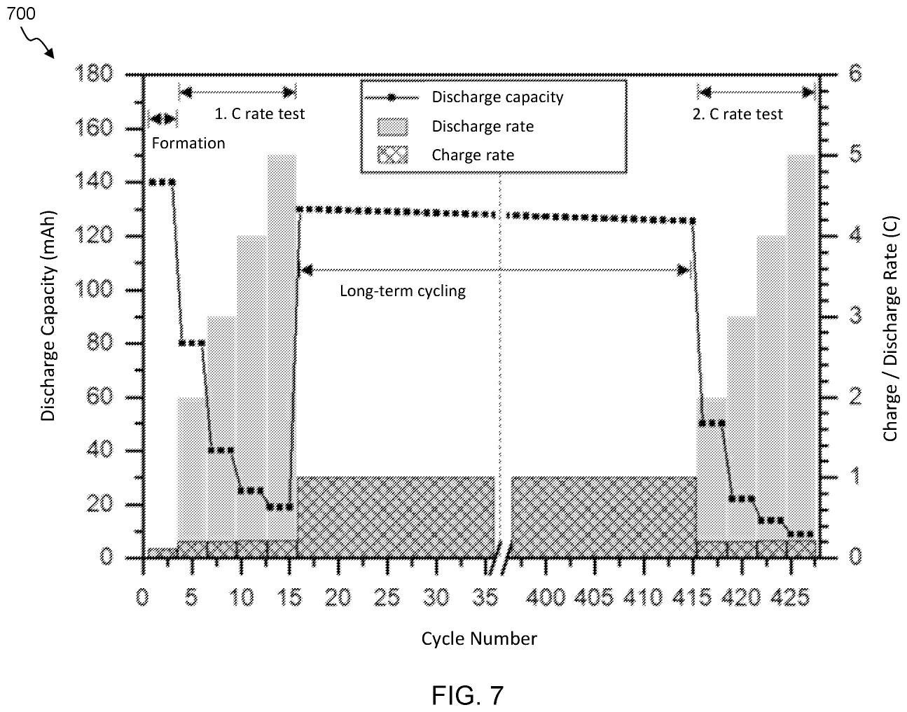

FIG. 7 is a graph 700 of an example testing process for a battery cell comprising a thin-gauge aluminum alloy as a cathode current collector. The graph 700 depicts example capacities at different currents. The charge rate and discharge rate are shown as bars, and the discharge capacities are shown as a black curve. The cells undergo an activation/formation process for three cycles with C/10. The load-dependent performance is then checked in a C-rate test. Here, C rates of 2, 3, 4, and 5 C are used. 400 cycles are then completed at 1 C, followed by a second C rate test.

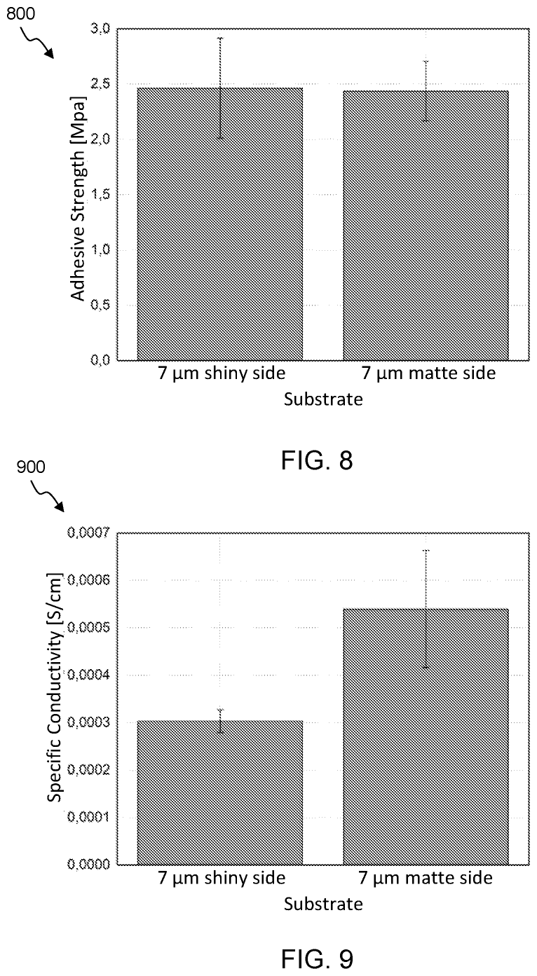

FIG. 8 is a graph 800 depicting resulting adhesive strength from pull-off tests performed on the thin-gauge aluminum alloy substrates. The graph 800 compares the adhesive strength in MPa for 7 μm thick cathodes coated on the shiny side versus the matte side. While the adhesive strength depicted in FIG. 8 did not show much difference between the shiny side and the matte side, the failure pattern after the pull-off test provided information about the underlying mechanisms. For example, the samples coated on the matte side showed little to no adhesive failure, and mainly cohesive failure. Adhesive failure was significantly more common in the samples coated on the shiny side. The adhesive strength of the coating on the cathode was therefore determined to be higher on the matte side of the aluminum alloy substrates.

FIG. 9 is a graph 900 depicting specific conductivity for battery cells comprising a thin-gauge aluminum alloy substrate as a cathode current collector. The graph 900 compares the specific conductivity in S/cm for cells including 7 μm thick cathode current collectors coated on the shiny side versus the matte side. The cells with the cathode current collectors coated on the matte side had a specific conductivity that was almost twice as high as the those with the cathode current collectors coated on the shiny side. However, the measurement includes a significant standard deviation. The increased specific conductivity of the cells with the cathode current collectors coated on the matte side may be due to the reduced interfacial resistance between the cathode current collectors and the coating.

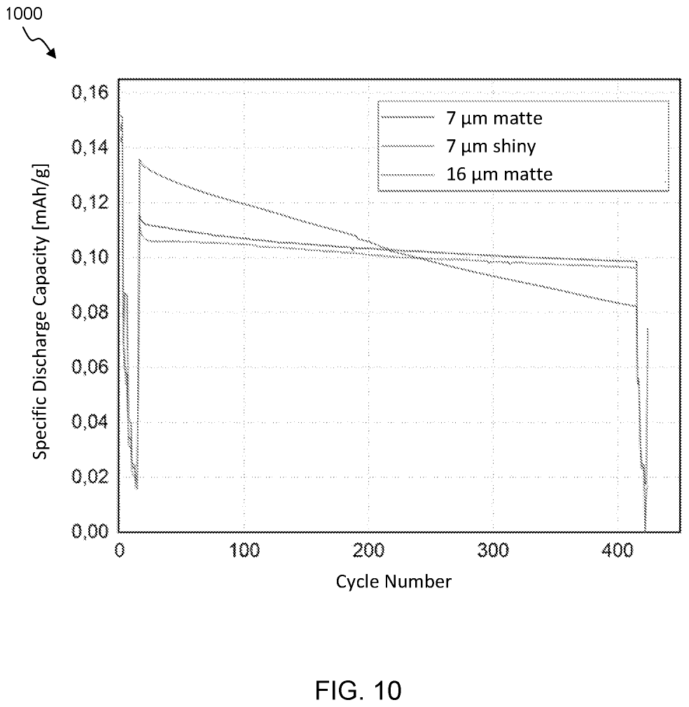

FIG. 10 is a graph 1000 depicting resulting specific discharge capacities from cycling tests performed on battery cells comprising a thin-gauge aluminum alloy substrate as a cathode current collector. The cells were cycled for a minimum of 4 weeks to cover the areas of formation, the first C rate test, and much of the long term cycling. Graph 1000 depicts the mean values of the specific discharge capacities as a function of cyclic age for cells including a 7 μm thick cathode current collector coated on the matte side, cells including a 7 μm thick cathode current collector coated on the shiny side, and cells including a 16 μm cathode current collector coated on the matte side. The 16 μm thick cathode current collector can corresponds to a conventional cathode current collector with a conventional thickness as a reference. The cells including 7 μm thick cathode current collectors exhibited significantly more stable capacity than the cell including a 16 μm thick cathode current collector, but lower initial capacities. From about 225 cycles, the cells including 7 μm thick cathode current collectors exhibited higher specific capacities than the cells including a 16 μm thick cathode current collector.

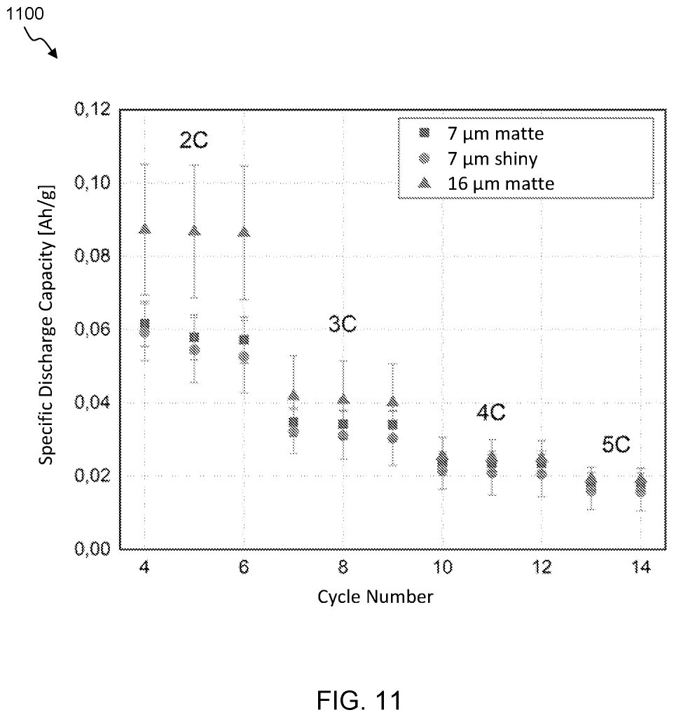

FIG. 11 is a graph 1100 depicting resulting specific discharge capacities during a C rate test performed on battery cells comprising a thin-gauge aluminum alloy substrate as a cathode current collector. The cell including a 16 μm thick cathode current collector exhibited a higher specific discharge capacity, especially at moderate C rates of 2 C and 3 C, followed by the cells including 7 μm thick cathode current collectors. With higher C rates, the differences between the measurements decreased. This may be due to the increasing limitation of ion transportation within the cathodes at high currents.

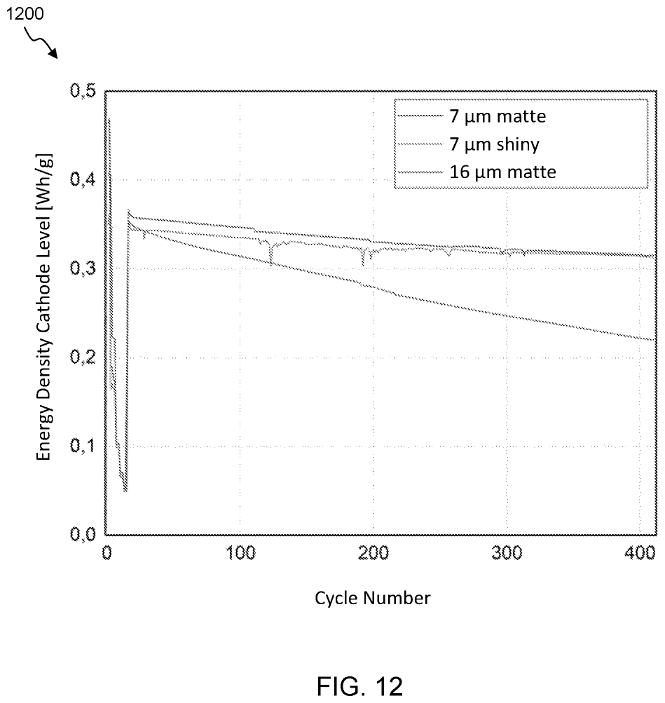

FIG. 12 is a graph 1200 depicting resulting energy density levels at the cathode level during cycling tests performed on battery cells comprising a thin-gauge aluminum alloy substrate as a cathode current collector. For this example, the energy during discharging was normalized to the mass of the cathodes. Due to the lower basis weight of the thin-gauge aluminum alloy cathode current collectors, the cells including 7 μm thick cathode current collectors exhibited higher energy densities than the cell including a 16 μm thick cathode current collector over the entire duration of the cycling tests.

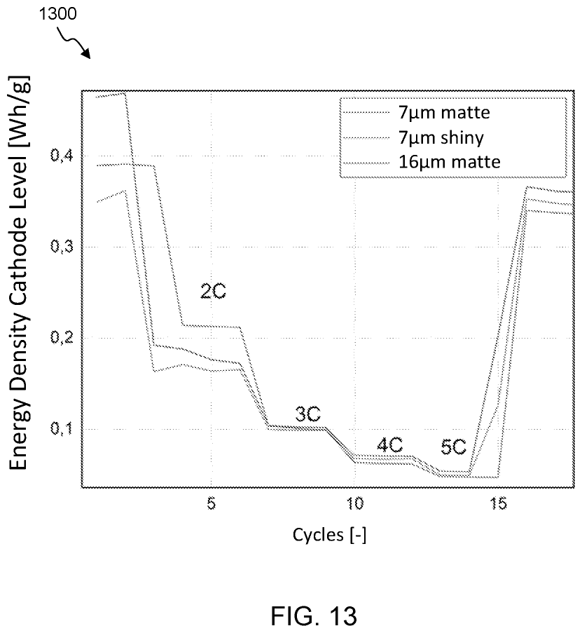

FIG. 13 is a graph 1300 depicting resulting energy density levels at the cathode level during C rate tests performed on battery cells comprising a thin-gauge aluminum alloy substrate as a cathode current collector. If the discharge energy at the cathode level is considered during the C-rate test, the differences between the cells including 7 μm thick cathode current collectors and the cell including a 16 μm thick cathode current collector are smaller than if the specific capacities are considered.

In summary, at over 2.5 MPa, the coating on the cathode current collectors have good adhesion. The conductivity with the cathodes coated on the matte side of the current collectors is significantly higher than the conductivity of the cathodes coated on the shiny side of the current collectors. Both the specific discharge capacity and the energy density at the cathode level are slightly higher for the cathodes coated on the matte side of the current collectors. Compared to the cells with 16 μm thick cathode current collectors, the cells with 7 μm thick cathode current collectors offer increased energy density and a higher life cycle or cycle stability (see FIG. 10).

### ILLUSTRATIVE ASPECTS

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a battery component comprising a cathode current collector comprising a 1xxx series aluminum alloy or an 8xxx series aluminum alloy, wherein the cathode current collector has a thickness of from 5 μm to 12 μm.

Aspect 2 is the battery component of any previous or subsequent aspect, further comprising: an active material layer disposed over at least a portion of the cathode current collector.

Aspect 3 is the battery component of any previous or subsequent aspect, wherein a side of the 1xxx series aluminum alloy or the 8xxx series aluminum alloy facing the active material layer is a shiny side or wherein a surface of the 1xxx series aluminum alloy or the 8xxx series aluminum alloy in contact with the active material layer has a shiny surface finish.

Aspect 4 is the battery component of any previous or subsequent aspect, wherein a side of the 1xxx series aluminum alloy or the 8xxx series aluminum alloy facing the active material layer is a matte side or wherein a surface of the 1xxx series aluminum alloy or the 8xxx series aluminum alloy in contact with the active material layer has a matte surface finish.

Aspect 5 is the battery component of any previous or subsequent aspect, wherein the active material layer is disposed over both sides of the 1xxx series aluminum alloy or the 8xxx series aluminum alloy.

Aspect 6 is the battery component of any previous or subsequent aspect, wherein both sides of the 1xxx series aluminum alloy or the 8xxx series aluminum alloy have matte surface finishes.

Aspect 7 is the battery component of any previous or subsequent aspect, wherein a conductivity between the active material layer and the cathode current collector ranges from 0.0275 S/m to 0.0675 S/m.

Aspect 8 is the battery component of any previous or subsequent aspect, wherein a conductivity between the active material layer and the cathode current collector ranges from 0.04 S/m to 0.0675 S/m.

Aspect 9 is the battery component of any previous or subsequent aspect, wherein the cathode current collector has a thickness from 7 μm to 12 μm.

Aspect 10 is the battery component of any previous or subsequent aspect, wherein the cathode current collector has a thickness from 7 μm to 10 μm.

Aspect 11 is the battery component of any previous or subsequent aspect, wherein the cathode current collector comprises a recycled content aluminum alloy.

Aspect 12 is the battery component of any previous or subsequent aspect, wherein the cathode current collector comprises up to 50% recycled aluminum content.

Aspect 13 is the battery component of any previous or subsequent aspect, wherein the battery component retains a specific capacity above 90% of an initial specific capacity for up to 3000 cycles.

Aspect 14 is the battery component of any previous or subsequent aspect, wherein the battery component retains an energy density above 90% of an initial energy density for up to 3000 cycles.

Aspect 15 is the battery component of any previous or subsequent aspect, further comprising a conductive layer disposed over at least a portion of a surface of the cathode current collector.

Aspect 16 is the battery component of any previous or subsequent aspect, wherein the conductive layer is a carbonaceous material.

Aspect 17 is the battery component of any previous or subsequent aspect, wherein the cathode current collector comprises the 8xxx series aluminum alloy, the 8xxx series aluminum alloy comprising Al and at least one of Si, Cu, Fe, or Zn.

Aspect 18 is the battery component of any previous or subsequent aspect, wherein the 8xxx series aluminum alloy comprises up to 0.3 wt. % Si, up to 0.05 wt. % Cu, up to 1.3 wt. % Fe, and up to 0.10 wt. % Zn.

Aspect 19 is the battery component of any previous or subsequent aspect, wherein the cathode current collector comprises the 8xxx series aluminum alloy and wherein the 8xxx series aluminum alloy is an 8079 series aluminum alloy, an 8090 series aluminum alloy, or an 8077 series aluminum alloy.

Aspect 20 is a method of making a battery component, the method comprising providing a cathode current collector comprising a 1xxx series aluminum alloy or an 8xxx series aluminum alloy, wherein the cathode current collector has a thickness of from 5 μm to 12 μm; and applying a cathode active material over a surface of the cathode current collector.

Aspect 21 is the method of any previous or subsequent aspect, further comprising subjecting the cathode current collector to a coating process to form a conductive layer.

Aspect 22 is the method of any previous or subsequent aspect, wherein the conductive layer is a carbonaceous material.

Aspect 23 is the method of any previous or subsequent aspect, wherein the cathode current collector comprises the battery component or metal product of any previous or subsequent aspect.

Aspect 24 is the battery component of any previous or subsequent aspect, prepared using the method of any previous or subsequent aspect.

Aspect 25 is a battery comprising the battery component or metal product of any previous or subsequent aspect.

Aspect 26 is the battery of any previous or subsequent aspect, comprising: an anode; and a cathode, wherein the cathode comprises the battery component or metal product of any previous or subsequent aspect as a cathode current collector; and a cathode active material in contact with the cathode current collector.

Aspect 27 is the battery of any previous or subsequent aspect, further comprising an electrolyte positioned between the cathode and the anode.

Aspect 28 is the battery of any previous or subsequent aspect, wherein the electrolyte is a liquid electrolyte or a solid electrolyte.

Aspect 29 is a method of preparing aluminum foils, the method comprising feeding three or more aluminum alloy sheets to a roll stand; co-rolling the three or more aluminum alloy sheets using the roll stand to reduce gauges of the three or more aluminum sheets and generate three or more aluminum alloy foils, wherein at least one of the aluminum alloys sheets has a top surface having a matte surface finish and a bottom surface having a matte surface finish.

Aspect 30 is the method of any previous or subsequent aspect, wherein the three or more aluminum alloy sheets comprise three aluminum alloy sheets, and wherein the three or more aluminum alloy foils comprise three aluminum alloy foils.

Aspect 31 is the method of any previous or subsequent aspect, wherein the three or more aluminum alloy sheets comprise four aluminum alloy sheets, and wherein the three or more aluminum alloy foils comprise four aluminum alloy foils.

Aspect 32 is the method of any previous or subsequent aspect, wherein the three or more aluminum alloy sheets all comprise the same aluminum alloy.

Aspect 33 is the method of any previous or subsequent aspect, wherein the at least one of the three or more aluminum alloy sheets comprises a different aluminum alloy from at least one other aluminum alloy sheet.

Aspect 34 is the method of any previous or subsequent aspect, wherein the three or more aluminum alloy sheets comprise 1xxx series aluminum alloys or 8xxx series aluminum alloys.

Aspect 35 is the method of any previous or subsequent aspect, wherein the three or more aluminum alloy sheets all have the same thickness or wherein the three or more aluminum alloy foils all have the same thickness.

Aspect 36 is the method of any previous or subsequent aspect, wherein the at least one of the three or more aluminum alloy sheets has a different thickness from at least one other aluminum alloy sheet or wherein the at least one of the three or more aluminum alloy foils has a different thickness from at least one other aluminum alloy foil.

Aspect 37 is the method of any previous or subsequent aspect, further comprising applying a coating onto at the top surface or the bottom surface of at least one of the aluminum alloys sheets having the top surface having the matte surface finish and the bottom surface having the matte surface finish.

Aspect 38 is the method of any previous or subsequent aspect, wherein the coating comprises an active material layer for a battery.

Aspect 39 is the method of any previous aspect, further comprising adjusting one or more rolling parameters to control gauge thicknesses of the three or more aluminum alloy foils, wherein the rolling parameters comprise a first feed rate of a first aluminum alloy sheet of the three or more aluminum alloy sheets, a second feed rate of a second aluminum alloy sheet of the three or more aluminum alloy sheets, a third feed rate of a third aluminum alloy sheet of the three or more aluminum alloy sheets, a pressure applied to the three or more aluminum alloy sheets by the roll stand, or a rolling speed of the roll stand.

Aspect 40 is a metal product comprising an aluminum alloy foil having a top surface having a matte surface finish and a bottom surface having a matte surface finish.

Aspect 41 is the metal product of any previous or subsequent aspect, wherein the matte surface finish has a specular gloss level of 30% or lower, 20% or lower, or 10% or lower.

Aspect 42 is the metal product of any previous or subsequent aspect, wherein the matte surface finish has a surface roughness of from 0.1 μm to 0.5 μm.

Aspect 43 is the metal product of any previous or subsequent aspect, wherein the matte surface finish is characteristic of processing by rolling against another aluminum alloy foil surface.

Aspect 44 is the metal product of any previous or subsequent aspect, wherein the aluminum alloy foil is a rolled aluminum alloy foil or wherein the aluminum alloy foil has an elongated grain structure characteristic of processing by rolling.

Aspect 45 is the metal product of any previous or subsequent aspect, wherein the aluminum alloy foil has a thickness of from 5 μm to 200 μm.

Aspect 46 is the metal product of any previous or subsequent aspect, wherein the aluminum alloy foil has a thickness of from 5 μm to 12 μm.

Aspect 47 is the metal product of any previous or subsequent aspect, further comprising a coating disposed over at least a portion of the aluminum alloy foil.

Aspect 48 is the metal product of any previous or subsequent aspect, wherein the coating comprises an active material layer for a battery.

Aspect 49 is the metal product of any previous or subsequent aspect, wherein the aluminum alloy foil comprises a 1xxx series aluminum alloy or an 8xxx series aluminum alloy.

Aspect 50 is the metal product of any previous or subsequent aspect, wherein the aluminum alloy foil comprises a recycled content aluminum alloy.

Aspect 51 is the metal product of any previous or subsequent aspect, wherein the aluminum alloy foil comprises an 8xxx series aluminum alloy including Al and at least one of Si, Cu, Fe, or Zn.

Aspect 52 is the metal product of any previous or subsequent aspect, wherein the 8xxx series aluminum alloy comprises up to 0.3 wt. % Si, up to 0.05 wt. % Cu, up to 1.3 wt. % Fe, or up to 0.10 wt. % Zn.

Aspect 53 is the metal product of any previous aspect, wherein the 8xxx series aluminum alloy is an 8079 series aluminum alloy, an 8090 series aluminum alloy, or an 8077 series aluminum alloy.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1. A battery component comprising:
a cathode current collector comprising a 1xxx series aluminum alloy or an 8xxx series aluminum alloy,
wherein the cathode current collector has a thickness of from 5 μm to 12 μm.

2. The battery component of claim 1, further comprising:
an active material layer disposed over at least a portion of the cathode current collector.

3. The battery component of claim 2, wherein a side of the 1xxx series aluminum alloy or the 8xxx series aluminum alloy facing the active material layer is a shiny side or wherein a surface of the 1xxx series aluminum alloy or the 8xxx series aluminum alloy in contact with the active material layer has a shiny surface finish.

4. The battery component of claim 2, wherein a side of the 1xxx series aluminum alloy or the 8xxx series aluminum alloy facing the active material layer is a matte side or wherein a surface of the 1xxx series aluminum alloy or the 8xxx series aluminum alloy in contact with the active material layer has a matte surface finish.

5. The battery component of claim 2, wherein the active material layer is disposed over both sides of the 1xxx series aluminum alloy or the 8xxx series aluminum alloy.

6. The battery component of claim 5, wherein both sides of the 1xxx series aluminum alloy or the 8xxx series aluminum alloy have matte surface finishes.

7. The battery component of claim 2, wherein a conductivity between the active material layer and the cathode current collector ranges from 0.0275 S/m to 0.0675 S/m.

8. (canceled)

9. The battery component of claim 1, wherein the cathode current collector has a thickness from 7 μm to 12 μm.

10. (canceled)

11. The battery component of claim 1, wherein the cathode current collector comprises a recycled content aluminum alloy.

12. (canceled)

13. The battery component of claim 1, wherein the battery component retains a specific capacity above 90% of an initial specific capacity for up to 3000 cycles.

14. The battery component of claim 1, wherein the battery component retains an energy density above 90% of an initial energy density for up to 3000 cycles.

15. The battery component of claim 1, further comprising:
a conductive layer disposed over at least a portion of a surface of the cathode current collector.

16. The battery component of claim 15, wherein the conductive layer is a carbonaceous material.

17. The battery component of claim 1, wherein the cathode current collector comprises the 8xxx series aluminum alloy, the 8xxx series aluminum alloy comprising Al and at least one of Si, Cu, Fe, or Zn.

18. The battery component of claim 17, wherein the 8xxx series aluminum alloy comprises up to 0.3 wt. % Si, up to 0.05 wt. % Cu, up to 1.3 wt. % Fe, and up to 0.10 wt. % Zn.

19. The battery component of claim 1, wherein the cathode current collector comprises the 8xxx series aluminum alloy and wherein the 8xxx series aluminum alloy is an 8079 series aluminum alloy, an 8090 series aluminum alloy, or an 8077 series aluminum alloy.

20. A method of making a battery component, the method comprising:
providing a cathode current collector comprising a 1xxx series aluminum alloy or an 8xxx series aluminum alloy, wherein the cathode current collector has a thickness of from 5 μm to 12 μm; and
applying a cathode active material over a surface of the cathode current collector.

21. (canceled)

22. (canceled)

23. (canceled)

24. (canceled)

25. A battery comprising the battery component of claim 1.

26. The battery of claim 25, comprising:
an anode; and
a cathode, wherein the cathode comprises
the battery component of claim 1 as a cathode current collector; and
a cathode active material in contact with the cathode current collector.

27. (canceled)

28. (canceled)

29. A method of preparing aluminum foils, the method comprising:
feeding three or more aluminum alloy sheets to a roll stand;
co-rolling the three or more aluminum alloy sheets using the roll stand to reduce gauges of the three or more aluminum sheets and generate three or more aluminum alloy foils, wherein at least one of the aluminum alloys sheets has a top surface having a matte surface finish and a bottom surface having a matte surface finish.

30-53. (canceled)
